(19) United States
(12) Patent Application Publication
(10) Pub. No.: US 2012/0199232 A1
(43) Pub. Date: Aug. 9, 2012

(54) CLAMP

(76) Inventor: David Mitchell, Carina Heights (AU)

(21) Appl. No.: 13/021,117

(22) Filed: Feb. 4, 2011

(51) Int. Cl. F16L 55/10

(52) U.S. Cl. 138/89

(57) ABSTRACT

A sealing clamp 1a for sealing at least one opening in a fluid line, said sealing clamp 1a comprising a pair of opposed jaws 2a, 3a connected to one another and movable between a clamping position and a non-clamping position; a handle 7a, 8a extending from each said jaw 2a, 3a for moving the jaws 2a, 3a between the clamping position and the non-clamping position; a biasing mechanism 6a for moving the jaws 2a, 3a to the clamping position; and at least one sealing member 4a associated with at least one said jaw 2a for sealing said opening when the jaws 2a, 3a are in the clamping position.

### TECHNICAL FIELD

The present invention concerns a sealing clamp for sealing an opening in a fluid line. In particular, the invention concerns a sealing clamp with at least one sealing member for sealing at least one opening in a fluid line.

### BACKGROUND OF THE INVENTION

In the automotive industry, fluid lines in the form of rigid or flexible pipes or hoses are used to convey fluids such as air, coolant, oil and fuel from one vehicle component to another. During servicing of a vehicle it may be necessary to disconnect or cut a fluid line, in which case fluid could leak from an opening in the fluid line unless manually sealed by a technician.

Depending on the nature of the fluid line and the fluid leaking therefrom, technicians may simply allow the fluid to drain from within the fluid line into a collection container (eg. pan), or temporarily seal the opening in the fluid line by way of a closure such as a plug, or temporarily close off a flexible fluid line by way of a hose clamp or by kinking the line.

Disadvantages with allowing fluid to drain into a collection container include that a container is required in close vicinity of the fluid line and this is not always possible, and additional handling of the contained fluid may be necessary.

Disadvantages with temporarily sealing an opening in the fluid line by way of a closure such as a plug include that different types of plugs may be needed to seal different sized and types of fluid lines, and a plug may be difficult to install and may damage the fluid line itself.

Disadvantages with temporarily closing off a fluid line by way of a line clamp or by kinking the line is that such techniques can only be used for flexible fluid lines, not rigid fluid lines. Also, such fluid lines may be damaged.

### SUMMARY OF THE INVENTION

The present inventor has now developed a sealing clamp that can be used to seal openings in many different types of fluid lines in a straight forward manner.

According to a first aspect of the present invention, there is provided a sealing clamp for sealing at least one opening in a fluid line, said sealing clamp comprising:

a pair of opposed jaws connected to one another and movable between a clamping position and a non-clamping position;

a handle extending from each said jaw for moving the jaws between the clamping position and the non-clamping position;

a biasing mechanism for moving the jaws to the clamping position; and

at least one sealing member associated with at least one said jaw for sealing said opening when the jaws are in the clamping position.

According to second aspect of the present invention, there is provided a method of sealing at least one opening in a fluid line with a sealing clamp, said sealing clamp comprising:

a pair of opposed jaws connected to one another and movable between a clamping position and non-clamping position;

a handle extending from each said jaw for moving the jaws between the clamping position and the non-clamping position;

a biasing mechanism for moving the jaws to the clamping position; and

at least one sealing member associated with at least one said jaw for sealing the at least one opening when the jaws are in the clamping position, said method comprising the steps of:

moving said pair of opposed jaws to the non-clamping position;

engaging the at least one sealing member with the at least one opening; and

allowing the jaws to move to the clamping position so as to clamp the fluid line and seal the at least one opening.

As used herein the term ‘fluid line’ refers to any conduit, tubing, pipe or hose, or conduit, tube, pipe or hose assembly within which fluid may be conveyed. The term is inclusive of any fitting attached to the conduit, tubing, pipe or hose that provides at least one opening requiring sealing. Examples of such fittings include couplers, connectors and adaptors. Such fittings can be barbed or threaded, for example. A banjo and a universal coupler are examples of fittings.

The pair of opposed jaws may be of any suitable size, shape and construction and formed of any suitable material or materials. Typically, the pair of opposed jaws will be made of metal or plastics material.

The pair of opposed jaws can be connected to one another in any suitable way that allows the pair of opposed jaws to move between the clamping position and the non-clamping position.

The jaws can cross over and the sealing clamp can comprise a pivot pin that extends through an aperture in each crossed over jaw (like a scissor arrangement). Alternatively, each jaw can comprise a yoke, the yokes can intermesh, and the sealing clamp can further comprise a hinge pin extending through openings in the intermeshed yokes. Alternatively, the jaws can be interconnected by way of the biasing mechanism itself, in which case the biasing mechanism could be a resilient leaf spring.

Each handle may be of any suitable size, shape and construction and can be made of any suitable material or materials. Each jaw may be integrally formed with a said handle. The sealing clamp can comprise a grip extending along each jaw.

The biasing mechanism may be of any suitable size, shape and construction and may be formed of any suitable material or materials. The biasing mechanism may be a spring interconnecting the jaws, such as a helical torsion spring or a leaf spring. Alternatively, if the jaws are interconnected by way of the biasing mechanism, the biasing mechanism could be a resilient leaf spring made of sprung steel or plastics material. In this instance, the jaws and biasing mechanism can be of integral construction.

The at least one sealing member may be of any suitable size, shape and construction and may be formed from any suitable material or materials. The at least one sealing member may be permanently fitted or releasably fitted (eg. press fitted) to the at least one jaw. If releasably fitted, then it may be replaced by other types of sealing members, if required.

The shape of the at least one sealing member will depend on the size and shape of the opening that requires sealing. The at least one sealing member may resemble a wedge or have a stepped periphery, for example. The at least one sealing member may be substantially hemispherical, for example. The at least one sealing member may be substantially flat yet flexible enough to adopt an appropriate shape so as to seal the opening.

The at least one sealing member may comprise a sealing portion for sealing the opening and the sealing portion may have a shape selected from the group consisting of a discoidal shape, a hemispherical shape, a wedge shape and a stepped outer periphery.

The at least one sealing member may comprise a neck extending from the sealing portion and a head extending from the neck, wherein the neck extends through an opening in said jaw said sealing member is releasably retainable by the jaw.

The at least one sealing member can be formed from a resilient and innate material such as hydrogenated nitrile butadiene rubber (‘HNBR’), elastomer, rubber, nitrile, neoprene, or any other suitable material able to form a fluid-tight seal when the at least one sealing member engages the at least one opening in the fluid line. It may be used for fluid lines containing fluid under pressures of 30 psi, for example.

In a first embodiment of the invention, one jaw of the sealing clamp can have a sealing member for sealing a single opening in a fluid line and the other jaw need not have one.

In a second embodiment of the invention, each jaw of the sealing clamp can have a sealing member for sealing two opposed openings in a fluid line (or possibly more than one fluid line).

In a third embodiment of the invention, one jaw of the sealing clamp can have a sealing member for sealing an opening in a fluid line and the other jaw can have an opening for (preferably snugly) receiving the fluid line and positively engaging/clamping to a region of the fluid line adjacent the fluid line opening. The opening can be a slit, slot or notch, for example. In this embodiment, jaw regions adjacent the opening can engage a flange, nut, barb, shoulder or collar of the fluid line. Preferably, the opening is selected from the group consisting of a slit and a notch, and said other jaw engages and abuts a part of the fluid line selected from the group consisting of a flange, a barb, a nut and a collar. Alternatively, the opening can be tapered in a general V-shape/wedge so as to positively engage the fluid line. Preferably the opening is a narrowing slit so as to positively engage and clamp to the fluid line. In this embodiment, one of the jaws seals, whereas the other jaw holds fast to another part of the fluid line such that the jaws can move to the clamping position.

Various embodiments of the invention will now be described, by way of example only, with reference to the following figures.

### BRIEF DESCRIPTION OF THE FIGURES

FIG. 1 is a front perspective view of a sealing clamp in a clamping position, according to an embodiment of the present invention;

FIG. 2 is a front perspective view of the sealing clamp shown in FIG. 1 but in a non-clamping position;

FIG. 3 is a front perspective view of another type of sealing clamp in a clamping position, according to an embodiment of the present invention;

FIG. 4 is a front perspective view of the sealing clamp shown in FIG. 3 but in a non-clamping position;

FIG. 5A is a perspective view of a fluid line having a banjo fitting;

FIG. 5B is a side view of another type of sealing clamp shown sealing openings in the banjo fitting shown in FIG. 5A, according to an embodiment of the present invention;

FIG. 6 is a side view of a sealing clamp, like the one shown in FIG. 1, sealing an opening in a flare fuel line, according to an embodiment of the present invention;

FIG. 7 is a detailed side view of a sealing clamp, like the one shown in FIG. 6, sealing an opening in a flanged fuel line;

FIG. 8 is a side view of a sealing clamp, like the one shown in FIG. 6, sealing an opening in an air conditioning pipe;

FIG. 9 is a side view of the sealing clamp, like the one shown in FIG. 6, sealing an opening in another type of air conditioning pipe; and

FIG. 10 is a side view of the sealing clamp, like the one shown in FIG. 6, sealing an opening in a flare brake line.

### DETAILED DESCRIPTION

In the figures, like reference numerals refer to like features.

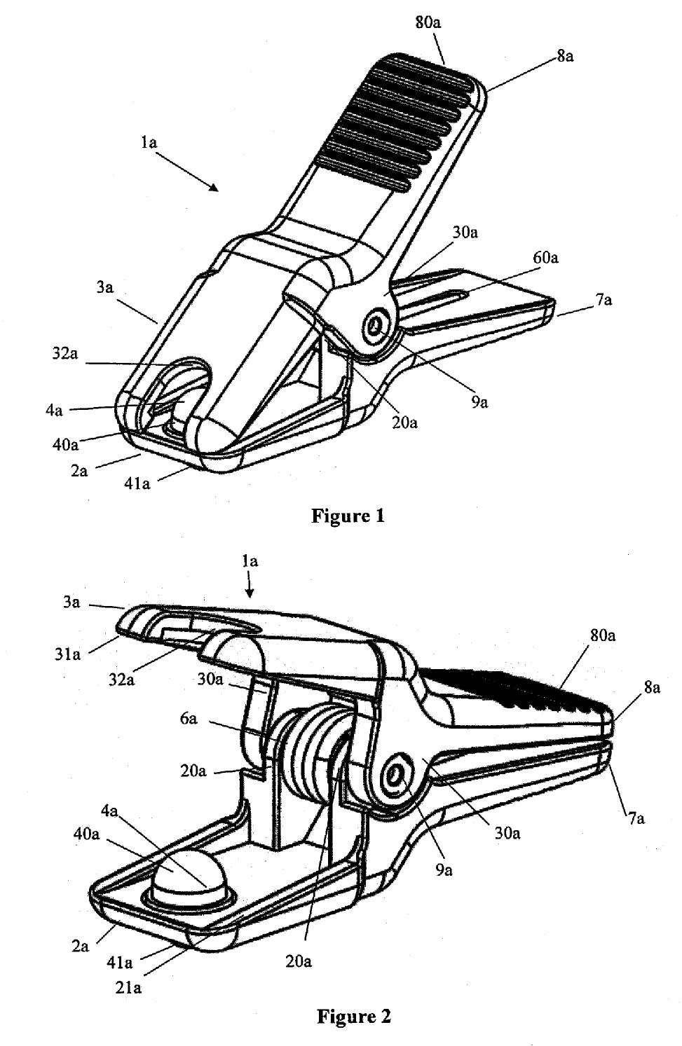

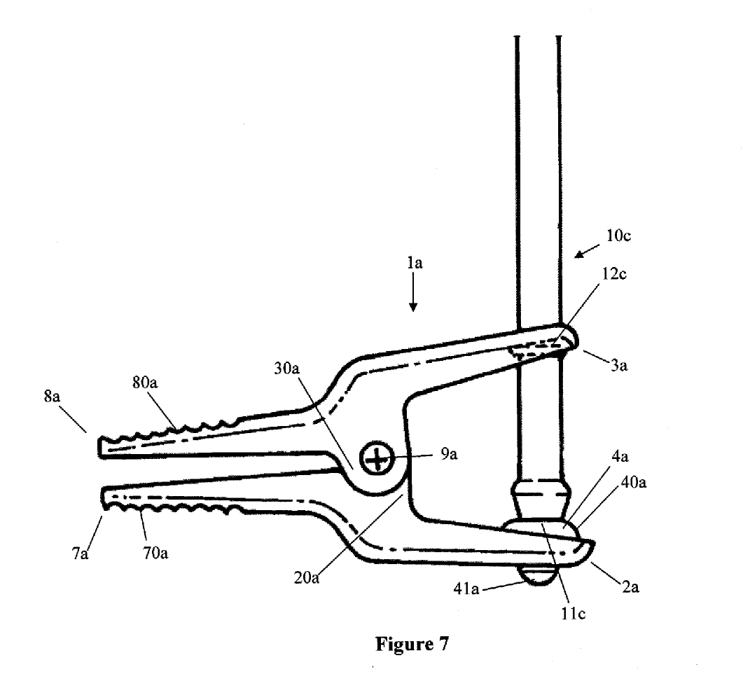

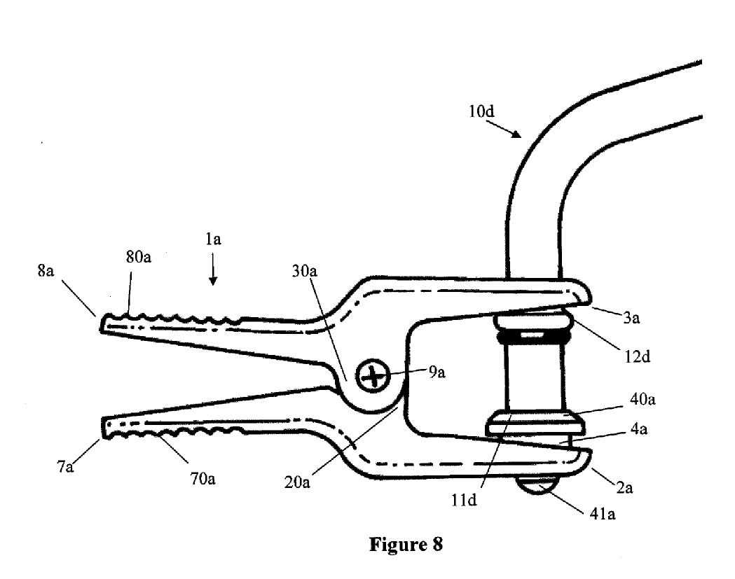

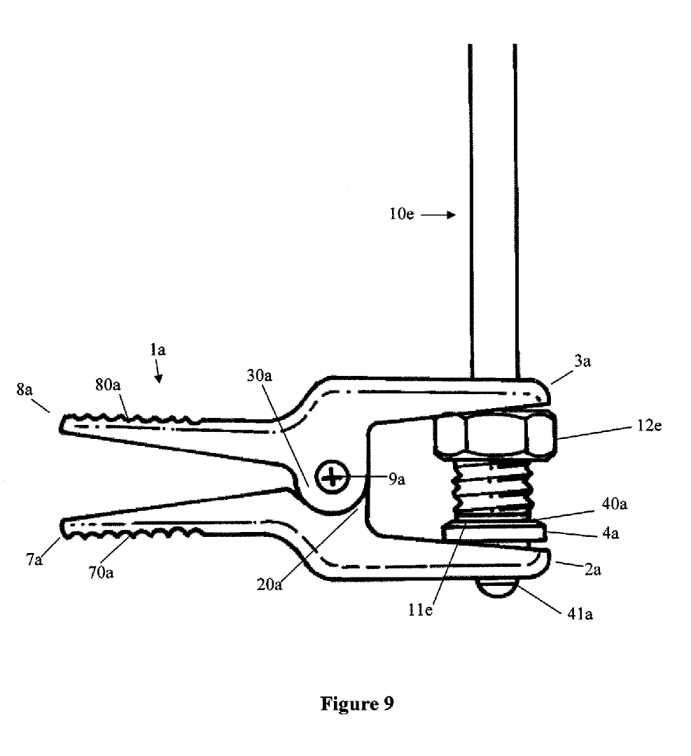

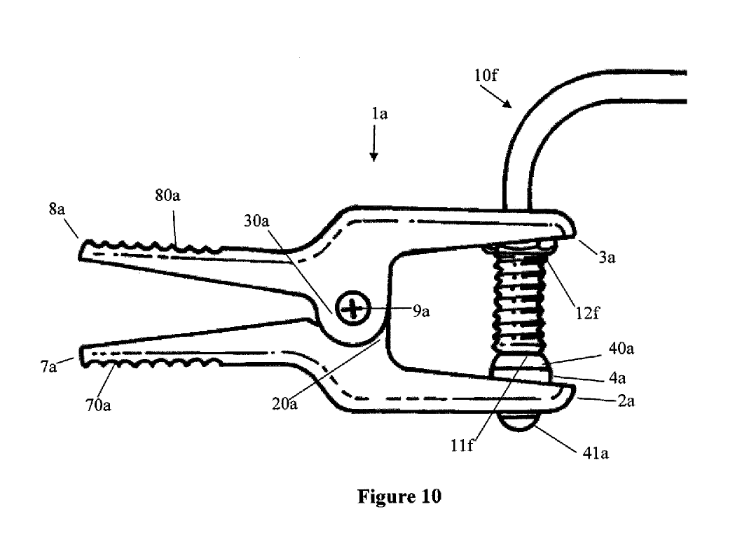

Each of FIGS. 1-4 and 5B-10 shows a sealing clamp 1 for sealing at least one opening 11 in a fluid line 10. The clamp 1 comprises a pair of metal jaws 2, 3 hingedly connected to one another and movable between clamping (see FIGS. 1, 3 and 5B-10) and non-clamping positions (see FIGS. 2 and 4), one or more rubber sealing members 4, 5 associated with one or more of the jaws 2, 3, a biasing mechanism 6 (shown in FIGS. 1, 2 and 4) for moving the jaws 2, 3 into the clamping position, a metal handle 7, 8 extending from each jaw 2, 3, and a metal hinge pin assembly 9 (nut and bolt).

Each jaw 2, 3 has a pair of yokes 20, 30 that intermesh with one another and the hinge pin assembly 9 extends through axially aligned coinciding openings in the intermeshed yokes 20, 30. Handle 7 extends from yoke pair 20 and is of unitary construction with jaw 2. Likewise, handle 8 extends from yoke pair 30 and is of unitary construction with jaw 3.

Each jaw 2, 3, has a clamping (working) end extending from the respective yoke pair 20, 30. Each clamping end has a continuous upturned (rolled-over) strengthening edge 21, 31 (only labelled in FIGS. 1-4) extending from the respective yoke pair 20, 30.

As seen in FIGS. 1 and 2, clamp 1a has a rubber sealing member 4a connected to jaw 2a and a slit 32a extending within the clamping end of jaw 3a.

As seen in FIGS. 1, 2 and 6-10, sealing member 4a comprises a generally hemispherical sealing portion 40a located at an inner surface of the jaw 2a that provides the sealing action, a neck (not shown) that snugly extends through an opening in the jaw 2a, and a barbed retaining head 41a that is located at an outer surface of the jaw 2a. The sealing portion 40a has a stepped periphery and is wedge-shaped.

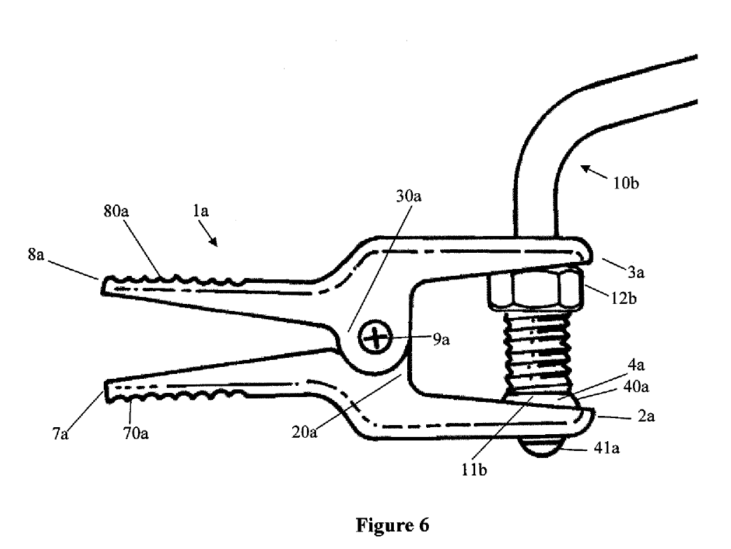

The slit 32a in the clamping end of jaw 3a is sized such that a fluid line 10b, 10c, 10d, 10e, 10f can extend there through but engage/abut a flange 12c, 12d or bolt 12b, 12e, 12f of the fluid line 10b, 10c, 10d, 10e, 10f, as shown in FIGS. 6-10.

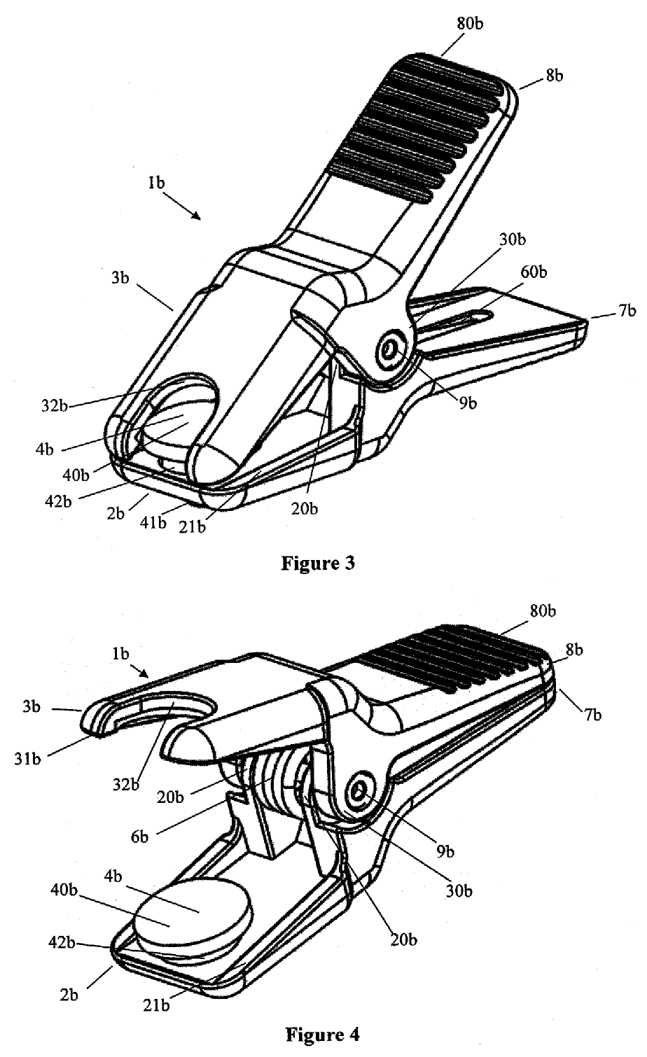

As seen in FIGS. 3 and 4, clamp 1b has a rubber sealing member 4b connected to jaw 2b and a slit 32b extending within the clamping end of jaw 3b.

The sealing member 4b comprises a generally flat discoid sealing portion 40b located at an inner surface of the jaw 2b that provides the sealing action, a neck 42b that snugly extends through an opening in the jaw 2b, and a retaining barbed head (not shown) that is located at an outer surface of the jaw 2b.

The slit 32b in the clamping end of jaw 3b is sized such that a fluid line can extend there through but engage/abut a flange or bolt of the fluid line, as described for clamp 1a.

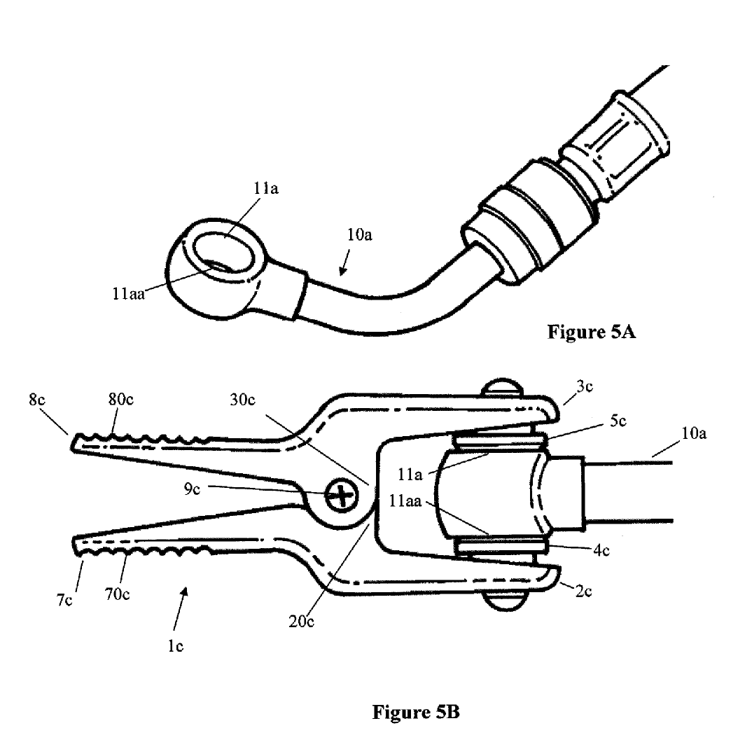

As seen in FIG. 5B, clamp 1c has a rubber sealing member 4c, 5c connected to a respective jaw 2c, 3c. The sealing members 4c, 5c are each shaped like sealing member 4a and are connected to the jaws 2c, 3c as described for member 4a. This dual sealing member 4c, 5c arrangement enables opposed openings 11a, 11aa of a fluid line having a banjo fitting 10a to be sealed.

Each handle 7, 8 has an outer surface along which extends a hand grip 70, 80. A groove extends (not labelled) along and within an inner surface of each handle 7, 8. Each handle 7, 8 has a continuous upturned (rolled-over) strengthening edge (not labelled) extending from the respective yoke pair 20, 30.

Each biasing mechanism 6 comprises a helical torsion spring 6 through which the hinge pin assembly 9 extends. The spring 6 has a pair of laterally extending free ends but only free end 60 is shown. Free end 60 extends within the groove in the inner surface of the handle 7, as seen in FIGS. 1 and 3. The other free end likewise extends within the groove in the inner surface of the other handle 8. The free ends 60 push apart the handles 7,8 such that the clamp 1 is biased to remain in the clamping position.

In use, the handles 7a, 8a of clamp 1a are squeezed together by a technician such that a fluid line 10b-10f can be extended through the slit 32a of the jaw 3a, the jaw 3a can engage/abut a flange/bolt 12b-12f of the fluid line 10b-10f and the sealing member 4a can engage an opening 11b-11f in the line 10b-10f. Once orientated in this manner, the technician releases his/her grip where upon the biasing mechanism 6a causes the clamp 1a to clamp to the fluid line 10b-10f and seal the opening 11b-11f in a fluid-tight manner. To unseal the opening 11b-11f, the technician merely squeezes together the handles 7a, 8a and disengages the clamp 1a from the fluid line 10b-10f.

Clamp 1b is operated in a similar manner to clamp 1a.

In use, the handles 7c, 8c of clamp 1c are squeezed together by a technician such that the sealing members 4c, 5c can engage openings 11a, 11aa in the banjo fitting 10, as shown in FIG. 5B. Once orientated in this manner, the technician releases his/her grip where upon the biasing mechanism causes the clamp 1c to clamp to the banjo fitting 10a and seal the openings 11a, 11aa in a fluid-tight manner. To unseal the openings 11a, 11aa, the technician merely squeezes together the handles 7c, 8c and disengages the clamp 1c from the fitting 10a.

Each sealing member 4, 5 may be either permanently fitted or releasably fitted (eg. press fitted) to the jaws 2, 3. If releasably fitted, then it may be possible to switch between different shaped and sized sealing members, as required by the technician.

The advantages of the sealing clamp as broadly described or exemplified include that:
i. the sealing clamp can be readily and easily applied to a fluid line opening, even within confined spaces;
ii. the sealing clamp can effectively seal very different types of fluid lines;
iii. the sealing clamp can effectively seal a fluid line with two openings such as, for instance, a fluid line having a banjo fitting;
iv. the biasing mechanism of the sealing clamp maintains a fluid-tight seal once the sealing clamp is fitted to a fluid line opening;
v. the biasing mechanism of the sealing clamp can maintain a fluid seal on pressurised fluid lines;
vi. the sealing clamp, once fitted, causes minimal or no damage to the fluid line; and
vii. the sealing clamp can be readily manufactured in a cost-effective manner.

The foregoing embodiments are illustrative only of the principles of the invention, and various modifications and changes will readily occur those skilled in the art will stop the invention is capable of being practice and carry out in various ways and in other embodiments. It is also to be understood that the terminology employed herein is for the purpose of description and should not be regarded as limiting.

The term “comprise” and variants of the term such as “comprises” or “comprising” are used herein to denote the inclusion of a stated integer or stated integers but not to exclude any other integer or any other integers, unless in the context of usage an exclusive interpretation of the term is required.

1. A sealing clamp for sealing at least one opening in a fluid line, said sealing clamp comprising:
a pair of opposed jaws connected to one another and movable between a clamping position and a non-clamping position;
a handle extending from each said jaw for moving the jaws between the clamping position and the non-clamping position;
a biasing mechanism for moving the jaws to the clamping position; and
at least one sealing member associated with at least one said jaw for sealing said opening when the jaws are in the clamping position.

2. The sealing clamp of claim 1, wherein one said jaw of the sealing clamp has a said sealing member.

3. The sealing clamp of claim 1, wherein each said jaw of the sealing clamp has a respective said sealing member.

4. The sealing clamp of claim 1, wherein one said jaw of the sealing clamp has a said sealing member and the other jaw comprises an opening for receiving the fluid line and positively engaging/clamping to a region of the fluid line adjacent the fluid line opening.

5. The sealing clamp of claim 4, wherein the opening is selected from the group consisting of a slit and notch, and said other jaw engages and abuts a part of the fluid line selected from the group consisting of a flange, barb, nut and collar.

6. The sealing clamp of claim 4, wherein the opening is a narrowing slit so as to positively engage and clamp to the fluid line.

7. The sealing clamp of claim 1, wherein the at least one sealing member comprises a sealing portion for sealing the opening and the sealing portion has a shape selected from the group consisting of a discoidal shape, a hemispherical shape, a wedge shape and a stepped outer periphery.

8. The sealing clamp of claim 1, wherein a sealing portion of the at least one sealing member is generally hemispherical in shape.

9. The sealing clamp of claim 7, wherein the at least one sealing member comprises a neck extending from the sealing portion and a head extending from the neck, wherein the neck extends through an opening in said jaw and said sealing member is retained by the jaw.

10. The sealing clamp of claim 9, wherein the at least one sealing member is releasably retained by the jaw.
